(19) United States
(12) Patent Application Publication
(10) Pub. No.: US 2007/0236033 A1
(43) Pub. Date: Oct. 11, 2007

(54) Remote controlled ladder rack

(76) Inventor: Lennox G. Newman, Palmetto Bay, FL (US)

Correspondence Address: LENNOX NEWMAN, 16355 S.W. 87 PLACE, PALMETTO BAY, FL, 33157, US

(21) Appl. No.: 11/398,441

(22) Filed: Apr. 5, 2006

(51) Int. Cl. B60P 3/00

(52) U.S. Cl. 296/3

(57) ABSTRACT

A Remote controlled electric ladder rack that afford easy removal and replacement of multiple ladders and limited materials above vans and trucks. The Remote controlled electric ladder rack utilizes the vehicles existing electrical supply to transport the multiple ladders from the top of the vehicle to the side horizontally for effortless removal by the user. The instant invention eliminates the need to climb above the vehicle or reach high above the user's head with a heavy load, for ladder/load access.

### 1. FIELD OF THE INVENTION

The present invention relates to the transportation and access to ladders and limited materials above high vehicles (e.g. Vans, high top vans, pickup trucks etc.)

### 2. DESCRIPTION OF RELATED ART

A few designs of roof racks do exists, however none of them involves an electric actuated articulating design, multiple ladder articulating capabilities, Limited material caring capabilities or full horizontal delivery for easy access.

Applicant believes that the closest reference corresponds to U.S. Pat. No. 6,099,231 issued to Levi, however it differs from the present invention because.

The system utilizes a series of high maintenance chains and sprockets in it's operation. And moves one ladder only to a high partial horizontal level. The system does not include a remote operation feature. Or the ability to transport additional load.

No other patents suggest the novel features of the present invention.

### SUMMARY OF THE INVENTION

The Remote controlled electric ladder rack that affords easy access to multiple ladders and limited materials transported above high profile vehicles, by transferring the load on command from the top of the vehicle to a low horizontal elevation beside the vehicle.

In the stored position Both multiple ladders and limited materials are stored securely on the Remote controlled electric ladder rack above the vehicle.

On the unload command the conveyance frame structure is moved by the actuator in a horizontal and downward motion to the side of the vehicle.

The gravitational energy is stored in an energy accumulator spring assembly as the load is lowered

On the store command the conveyance frame structure is moved vertically by the actuator and the stored energy in the energy accumulator spring assembly. the horizontal movement is performed by the actuator only.

### BRIEF DESCRIPTION OF THE DRAWINGS

With the above and other related objects in view, the invention consists in the details of construction and combination of parts as will be fully understood from the following description, when read in conjunction with the accompanying drawings.

FIG. 1 Depicts a side view of the primary electric ladder rack assembly with the actuator and primary control arm in the stored position. The ladder/load and a typical van roof top in broken lines.

FIG. 2 Depicts a front view of the primary electric ladder rack assembly with the energy accumulator spring In the stored position.

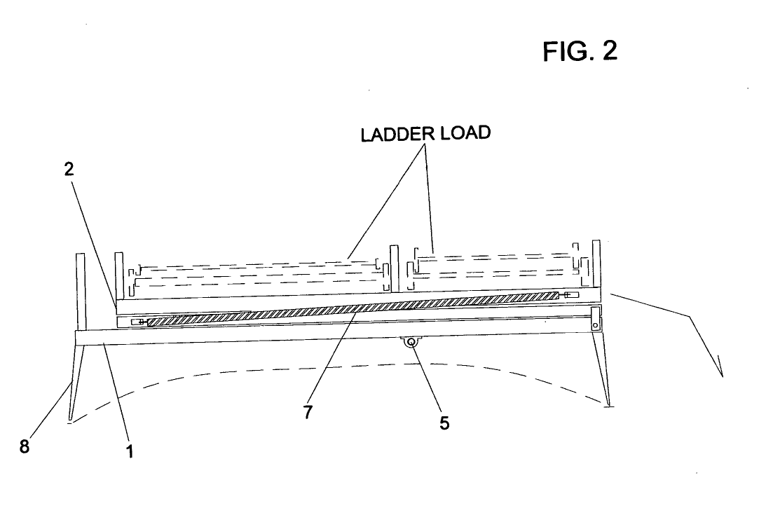

FIG. 3 Depicts a front view of the secondary electric ladder rack assembly with the secondary control arm shown in the stored position.

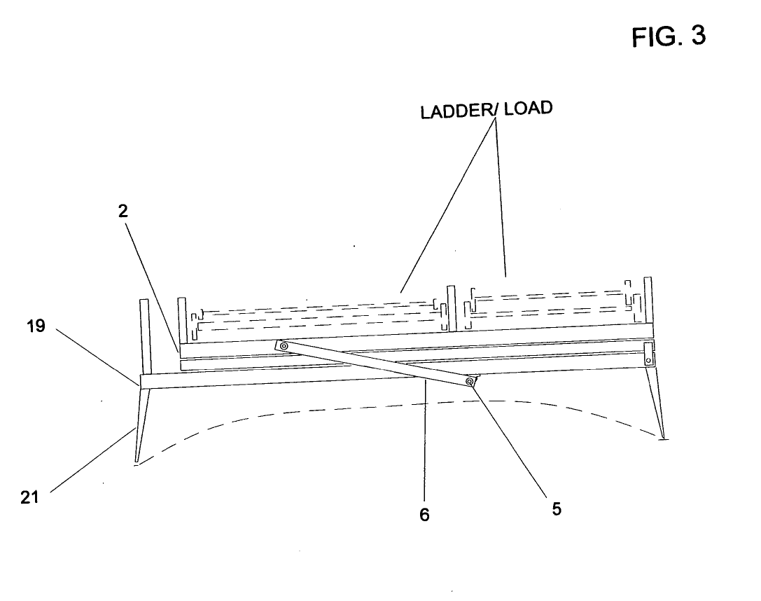

FIG. 4 Depicts a side view of the electric ladder rack assembly with the transfer rod, control arms, legs and actuator shown in the stored position.

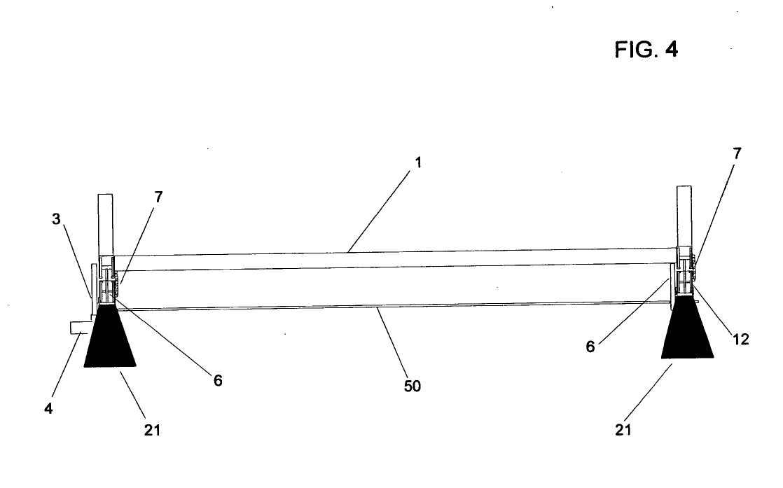

FIG. 5 Depicts a top view of the electric ladder rack assembly with the above mentioned components shown in the stored position.

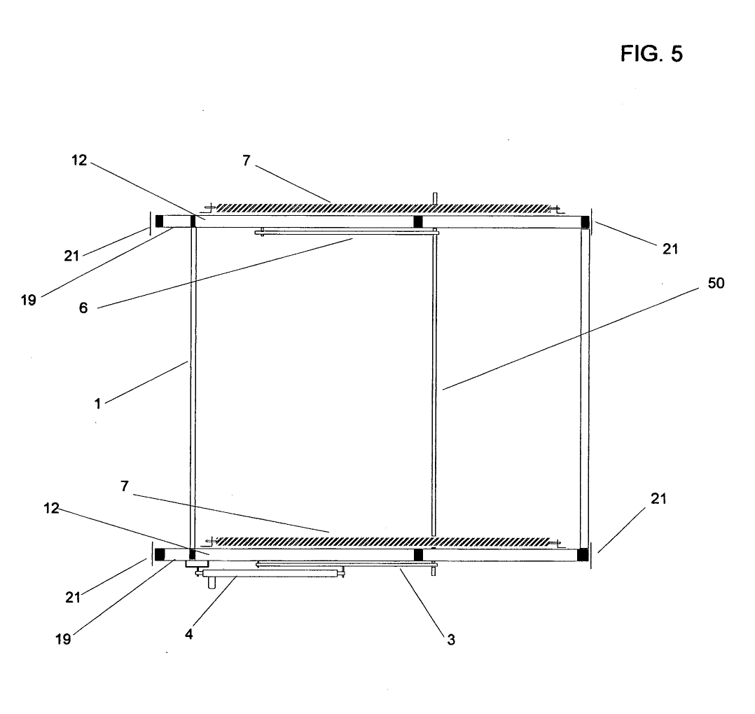

FIG. 6 Depicts the electric ladder rack in the down position. A typical van and ladder/load is shown in broken lines.

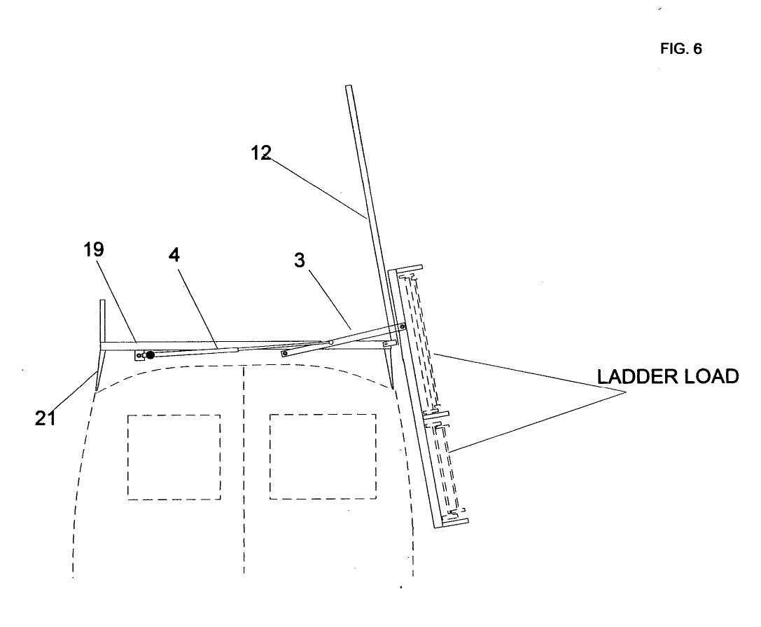

### DETAILED DESCRIPTION OF THE PREFERRED EMBODIMENT

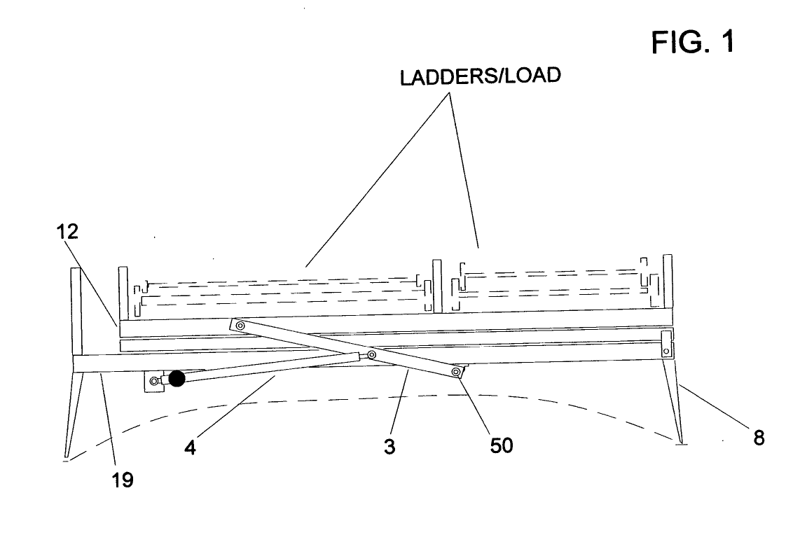

Referring now to the drawings and particularly to FIG. 1 a remote controlled electric ladder/load rack is depicted in rear side view stored position. The Actuator apparatus 4, the primary control arm 3, the transfer rod 50, the track assembly 12, the frame cross member 19 and the support legs 21 are shown.

The ladder/load are also depicted in broken lines.

The Remote controlled ladder rack may consist of four or more support legs 21.

The frame cross member 19, the track assembly 12 and conveyance frame 1 are constructed from a suitable Material.

Upon receiving the down command the actuator member 4 moves outwards forcing the primary control arm 3, upwards, the torque force is simultaneously transmitted via the transfer rod 50 to the secondary control arm 6, which them duplicates the movement of the primary assembly. As the assembly continues the upwards movement the track assembly 12 moves outwards proportional to the upwards and lateral movement of the control arms 4& 6. The now extending conveyance frame 1 moves in an outward and downwards motion lowering the ladder/load horizontally for easy access.

This invention is suitable to be used in any application where a load is normally stored too high to be safely retrieved by a normal person, and moving the load to within easy reach of the person is the best solution.

Only a portion of the mechanism means has been illustrated enough to describe the invention, it is understood that variation in these elements of structure to obtain the same results is within the scope of the invention.

As can be readily understood from the foregoing description of the invention, the present structure can be configured in different modes with varying materials. Accordingly, the foregoing description conveys the best understanding of the objective and advantages of the present invention. Different embodiments may be made of the inventive concept of this invention. It is to be understood that all mater disclosed herein is to be interpreted merely as illustrative, and not in a limiting sense.

What is claimed is:

1. A wireless remote operated electric ladder rack, comprising.
A) a frame structure
B) a conveyance frame structure, said conveyance frame structure being affixed to the frame structure.
C) a track assembly, said track assembly being affixed to the frame structure and the conveyance frame structure.
D) an electric actuator for powering the conveyance frame structure.
E) an energy accumulator spring assembly being affixed to the track assembly.
F) a wireless remote control device for up and down operation.

2. The Remote controlled electric ladder rack according to claim 1, further characterized in that said Remote controlled ladder rack transport multiple ladders from the top of a vehicle to a low horizontal elevation within easy reach beside the vehicle for removal and replacement of the ladder/load.

3. The Remote controlled electric ladder rack according to claim 2, further characterized in that said frame structure is secured to the vehicle's roof.

4. The Remote controlled electric ladder rack according to claim 3, further characterized in that said articulating sub structure travels perpendicular to the frame structure and descends to lower the load to the horizontal level.

5. The Remote controlled electric ladder rack according to claim 4 further characterized in that said energy accumulator for storing the energy generated by the gravitational force of the lowering load

6. The Remote controlled electric ladder rack according to claim 5, further characterized in that said remote control affords total control with maximum supervision during operation.
